(19) United States
(12) Patent Application Publication
(10) Pub. No.: US 2011/0141859 A1
(43) Pub. Date: Jun. 16, 2011

(54) TIMEPIECE COMPRISING A HAND-SETTING MECHANISM CONTROLLED BY A ROTATING BEZEL

(75) Inventors: Alberto Papi, La Chaux-de-Fonds (CH); Giuliano Mazzuoli, Tavarnelle V.P. Firenze (IT)

(73) Assignee: Giuliano Mazzuoli S.R.L., Tavarnelle V.P. Firenze (IT)

(21) Appl. No.: 12/294,948

(22) PCT Filed: Mar. 22, 2007
(86) PCT No.: PCT/EP2007/052740

§ 371 Date: Sep. 29, 2008

(30) Foreign Application Priority Data
Mar. 29, 2006 (CH) CH00503/06

(51) Int. Cl. G04B 27/04; G04B 27/02

(52) U.S. Cl. 368/192; 368/190

(57) ABSTRACT

A timepiece includes a case with a rotating bezel, time display elements, and a hand-setting mechanism which includes a hand-setting stem housed entirely inside the case and movable between at least a first axial position and a second or hand-setting axial position. Connection elements capable of enabling a kinematic connection to be established between the rotating bezel and the hand-setting stem are provided so that turning the rotating bezel turns the hand-setting stem. The timepiece also includes a lever for external control, which pivots on the case via a connecting stem and which has an end portion movable between at least a first position and a second or hand-setting position. A control mechanism is provided to act on the hand-setting stem and move it from one axial position to the other in response to action on the control lever.

### TECHNICAL FIELD

The present invention concerns a timepiece of the type comprising a case with a rotating bezel, time display means, and a hand-setting mechanism. In particular, this last comprises a hand-setting stem housed entirely inside the case and movable between at least a first axial position and a second hand-setting axial position. The timepiece also comprises connection means capable of enabling a kinematic connection to be established between the rotating bezel and the hand-setting stem in such a way that turning the rotating bezel turns the hand-setting stem.

### BACKGROUND OF THE INVENTION

Timepieces of this type have been known for a long time in the prior art. As an example, patent CH 136 087 describes such a timepiece in which the hand-setting stem has two axial positions, one for winding, and the other for setting, the passage from one position to the other being done by an action by a user on an external control member of the bolt type, i.e. mounted slidingly in the case. Moreover, the timepiece described in this document comprises means to provide a permanent kinematic connection between the rotating bezel and the hand-setting stem, such that winding and setting are done directly from the rotating bezel.

However, a well known problem of sliding control members, frequent in particular in timepieces with striking-work, resides in the difficulty of ensuring sealing of the case in the region where this control member is implanted. Moreover, untimely manipulation of a control member of this type is possible, in particular on a timepiece worn on the wrist.

### BRIEF SUMMARY OF THE INVENTION

The primary aim of the present invention is to propose an original alternative to the abovementioned device of the prior art, while resolving the drawback, by proposing a timepiece in which the control, in particular of the hand-setting mechanism, is done using a secure control member, and the implantation mode of which in the case does not compromise the sealing of the timepiece. To this end, the present invention more particularly concerns a timepiece of the type mentioned above, characterized by the fact that it also comprises a lever for external control, mounted pivoting on the case, and an end portion of which is movable between at least a first position and a second, hand-setting position. It is provided that a control mechanism is arranged to act on the hand-setting stem and to move it from one axial position to the other in response to an action exerted on the control lever causing a movement of its end portion between one position and the other, to enable actuation of the hand-setting mechanism by turning the rotating bezel.

More precisely, it is advantageously provided that the lever is mounted integral with a connecting stem, pivoting in the middle of the timepiece while being substantially perpendicular to the general plane of the middle, this stem also being integral with a first internal lever of the control mechanism. Preferably, this stem can be housed in a hole of the middle at the at least partially-cylindrical wall, with interposition of an O-ring to ensure sealing of the corresponding opening.

Thanks to these characteristics, the timepiece has a form which is both original and functional due to the fact that untimely manipulations of the external control lever are unlikely, while the means necessary to ensure sealing of the timepiece are well controlled, as they are similar to those currently used to seal the opening required for the passage of a hand-setting stem through a case.

One additional aim of the present invention is to facilitate the manipulations of a user wishing to actuate the time setting mechanism of the timepiece.

To this end, the control mechanism according to the present invention also comprises a second internal lever, mounted pivoting around an axis X on a movement frame of the timepiece, and extending along a transverse direction in reference to the longitudinal direction of the hand-setting stem. This second internal lever advantageously comprises a region for receiving a force transmitted from the external control lever and a support surface arranged so as to cooperate at least indirectly with the hand-setting stem, the reception region and the axis X being arranged on both sides of a plane P containing the axis of the hand-setting stem, respectively, and perpendicular to the general plane of the second lever.

Thanks to these characteristics, the force to be exerted by the user on the lever for external control to cause the hand-setting stem to move is relatively weak and allows easy manipulation of the external control lever.

It is also provided that the control mechanism comprises at least one additional internal lever arranged to move a clutch-pinion supported by the hand-setting stem, simultaneously with the movements of the hand-setting stem between one and the other of its axial positions.

The timepiece according to the invention comprises other advantageous characteristics, such as an intermediate position of the external control lever provided to allow winding of the movement.

### BRIEF DESCRIPTION OF THE DRAWINGS

Other characteristics and advantages of the present invention will appear more clearly upon reading the detailed description of one preferred embodiment which follows, done in reference to the appended drawings provided as non-limiting examples and in which:

FIG. 1 illustrates a simplified transverse cross-sectional view of the timepiece movement according to one preferred embodiment of the present invention;

FIG. 2 is a partial and simplified transverse cross-sectional view of a detail of construction of the timepiece according to one preferred variation of embodiment of the present invention, the cross-section plane being different from that of FIG. 1;

FIG. 3a is a simplified top view of one detail of construction of the movement of FIG. 1, in a first configuration;

FIG. 3b is a top view similar to the view of FIG. 3a, in a second configuration, and

FIG. 3c is a top view similar to the view of FIG. 3a, in a third configuration.

### DETAILED DESCRIPTION OF THE INVENTION

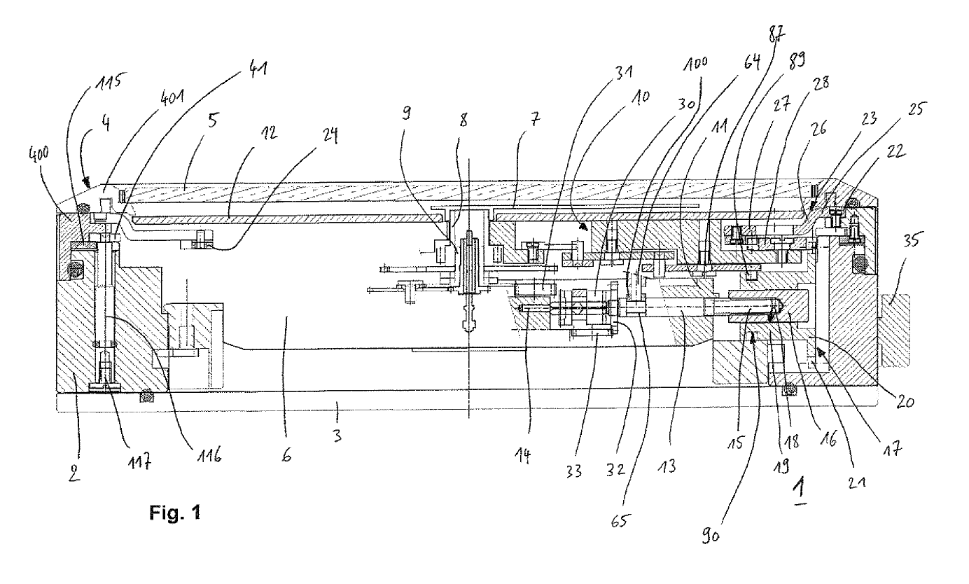

FIG. 1 illustrates a simplified transverse cross-section of a timepiece 1 according to one preferred embodiment of the present invention.

The timepiece 1 includes a case comprising a middle 2, defined, on one hand, by a bottom 3 and, on the other hand, by a rotating bezel 4 supporting a glass 5. The case contains a clockwork movement 6 whereof some components are diagrammed in FIG. 1. The clockwork movement can be of the electromechanical or mechanical type. It is in particular intended to drive time display members, including an hour hand 7, supported by an extension tube 8 integral with the pipe of the hour wheel 9, illustrated in this figure as an example. One will note that the timepiece movement 6 is topped by an additional module 10 from the side of its plate 11, namely from the side of the glass. This additional module 10 includes a control mechanism which will be described in more detail below. Thus, the extension tube of the cannon of the hour wheel makes it possible to go through the thickness of the additional module to drive the hour hand.

The hour hand 7 evolves between a frame 12 and the glass 5, traditionally. The hand-setting stem 13 is provided to complete the setting of the display members. The hand-setting stem is arranged in a hole of the plate, and entirely arranged inside the case, in accordance with the characteristics of the present invention. A first end 14 of the hand-setting stem is located in the region of the hour wheel, in a known manner, while its second end 15 is located between the periphery of the movement and the middle 2, a sleeve 16, with a square transverse section, being screwed on this second end.

A pinion 17 is mounted on the sleeve 16 while being free to slide through a hole 18 arranged in a cylindrical primary portion 19, this last part ending with a toothed disc 20 and coaxial to the principal portion. The hole 18 has a shape adapted so that the pinion 17 is integral in rotation with the sleeve 16. The disc 20 has a diameter such that its toothing 21 is located across from the periphery of the additional module.

Moreover, the rotating bezel 4 is made up of two parts, non-limitingly, a lateral part 400 and an upper part 401 between which is screwed, by its external periphery 22, a first ring 23, supporting a second ring 24 having a toothing oriented outwardly. These elements are as a result all integral in rotation. The two parts of the bezel can in particular be assembled by notches, or by screwing.

The first ring 23 has, from its external periphery integral with the rotating bezel toward its internal periphery supporting the second ring 24, a first portion 25 extending substantially along a first plane parallel to the general plane of the middle, a second portion 26 tilted in the direction of the bottom of the timepiece, and a third portion 27 extending substantially along a second plane parallel to the general plane of the middle.

The distance separating the first plane from the second plane is greater than the height separating the rotating bezel from the frame. Thus, the frame can have a radius greater than that of the internal edge of the upper part 401 of the rotating bezel to conceal all of the elements other than those which are arranged above it.

The toothing of the second ring 24 is arranged so as to be permanently engaged with a wheel, or pinion, 28 mounted rotatingly on the frame of the additional module.

The configuration of the timepiece illustrated in FIG. 1 corresponds to its winding position. In this configuration, the toothing 21 of the pinion 17 is engaged with the pinion 28 to provide the kinematic connection between the rotating bezel 4 and the hand-setting stem. Thus, any turning of the rotating bezel is transmitted to the hand-setting stem via the pinion 28.

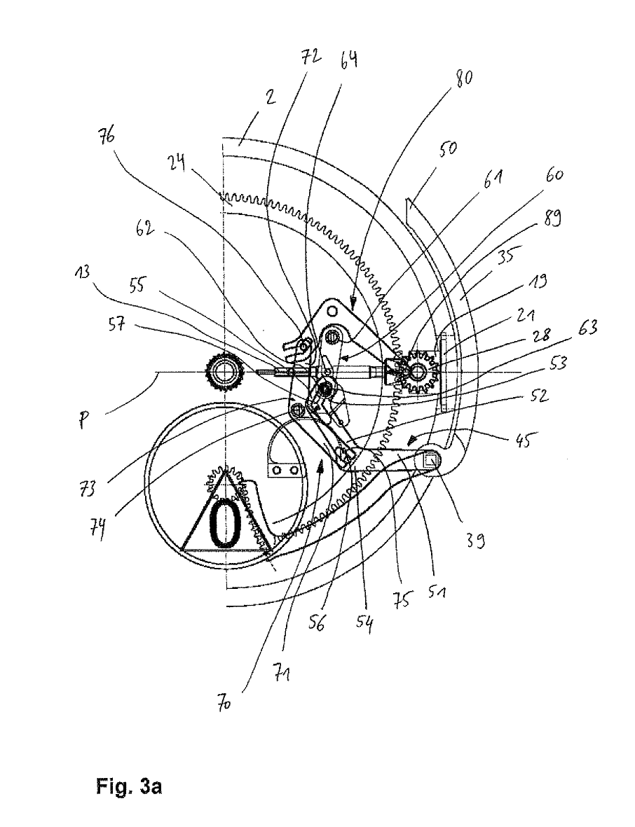

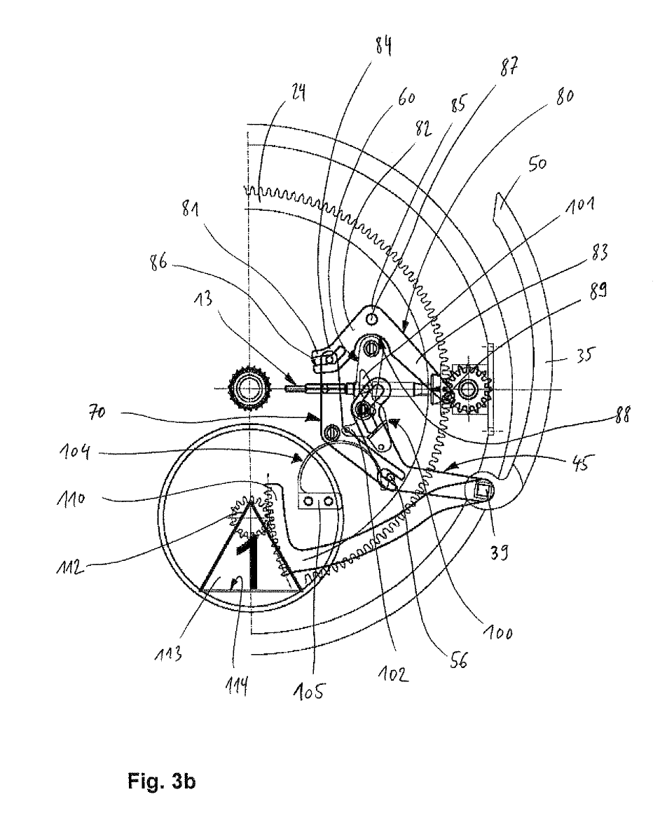

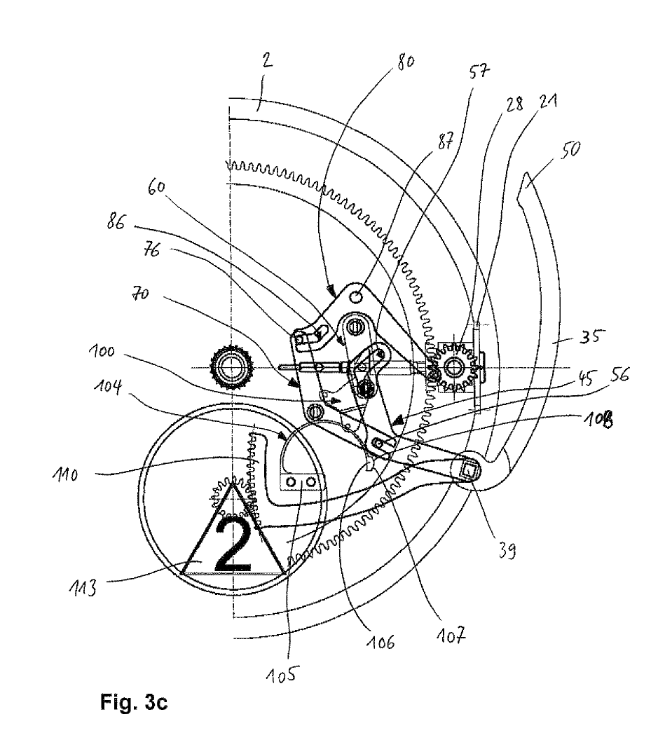

Moreover, the hand-setting stem supports a clutch-pinion 30 of the traditional type, in the region of its first end 14. This is able to move along a square of the hand-setting stem, in the axial direction of the latter part, between an initial position farther away from the first end 14 and a setting position close to this end 14. To this end, the movement comprises a lever cooperating with an annular groove of the pinion sliding via a stud, one part of which is visible in cross-section in this figure, to control its movements. This lever will be described in more detail in relation to FIGS. 3a to 3c.

The clutch-pinion 30 is designed to be arranged engaged with a setting wheel 31, in the setting configuration, the wheel itself being arranged on the plate of the movement while being permanently engaged with the hour wheel 9. As a result, the rotations of the rotating bezel, in this configuration, are transmitted to the hour wheel, therefore to the hour hand, to allow adjustment of its position.

In a preferred and non-limiting manner, the illustrated timepiece is of the mechanical type, the hand-setting stem also being used to perform winding of a barrel spring (not illustrated). For this purpose, a winding pinion 32 is mounted free in rotation and in translation on the stem 13. The winding pinion can be driven in rotation in a single direction by the sliding pinion, traditionally, when the latter part is in its winding position, corresponding to the initial position previously defined. The winding pinion is arranged permanently engaged with a crown wheel 33, connected to the barrel arbor (not visible).

The timepiece according to the present invention thus preferably comprises three different configurations, preferably associated with three different positions of an external control member: a first neutral position, in which the rotations of the rotating bezel have no impact on the operation of the movement, a second winding position in which the rotations of the rotating bezel in a predetermined direction make it possible to recharge a barrel spring, and a third setting position in which the rotations of the rotating bezel in one direction or the other make it possible to adjust the position of the time display members.

In the present preferred embodiment of the invention, the external control member advantageously assumes the form of a lever 35 cooperating with the control mechanism arranged in the additional module of the timepiece, which will be described in more detail in relation to FIGS. 3a to 3c.

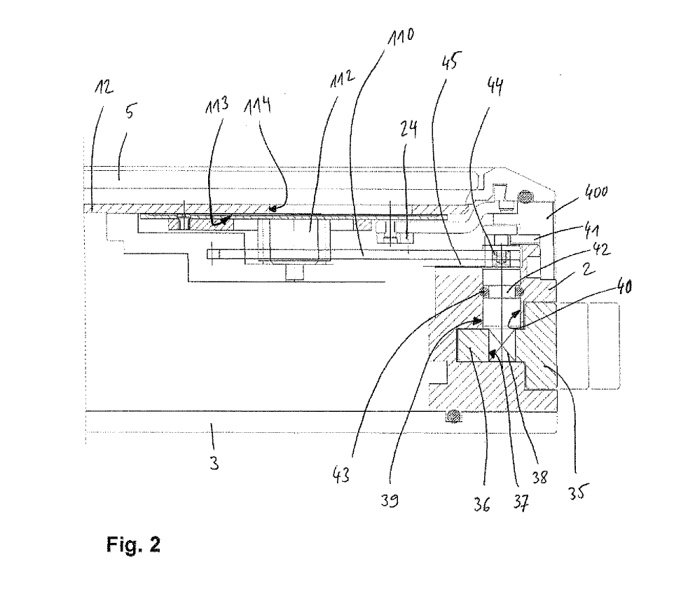

FIG. 2 illustrates a transverse cross-section of the timepiece 1 along a cross-section plane different from that of FIG. 1, showing the nature of the mechanical connection means implemented to transmit the movements of the external control lever 35 to the control mechanism, located inside the case.

The lever 35 presents a fixing portion 36 inserted into a recess of the middle and comprising a hole 37 with a square section, this being passed through by a first end 38 of a connecting rod 39 defining a rotation arbor of the lever 35 in relation to the middle 2.

The stem 39 has a section complementary to that of the hole 37 of the lever to ensure driving in rotation of the stem according movements of the lever. Moreover, the stem is mounted free in rotation in a hole 40 of the middle whereof the wall has a generally cylindrical shape. Axial maintenance of the stem 39 in the hole of the middle is guaranteed by a blocking ring 41, maintained bearing against the middle by the lateral portion 400 of the rotating bezel 4, and arranged in the extension of the stem.

Preferably, an annular groove 42 is arranged in the central region of the connecting stem 39 to house an O-ring 43, designed to be interposed under stress between the stem 39 and the wall of the hole 40 of the middle to ensure the sealing of the case there.

The connecting stem 39 has a second portion 44 with a square section in the region of its second end located inside the case of the timepiece. This second portion 44 of the stem is integral with a first lever 45 of the control mechanism, such that the rotational movements of the external control lever 35 are retransmitted to the control mechanism, inside the case.

Thanks to this clever construction, sealing of the case can be ensured reliably and effectively. In fact, other than a specific orientation allowing original transmission of the movements of the external control member, the arrangement of the means designed to seal the case is similar to that commonly used in horology.

The three possible positions of the external control lever are diagrammed illustratively in FIG. 2, these positions corresponding to the three configurations of the timepiece mentioned above.

FIGS. 3a, 3b and 3c illustrate simplified top views of a detail of the movement of the timepiece when this presents these first, second and third configurations, respectively.

More precisely, these figures illustrate component elements of the additional module comprising the control mechanism according to one preferred embodiment of the present invention. Out of a concern for clarity, the numerical references of the elements which will be described in the continuation of the text are distributed over the three FIGS. 3a, 3b and 3c.

FIG. 3a illustrates the timepiece when the external control lever 35 is in its locking position, namely when it is arranged along the middle. Preferably, one can provide that the case (not illustrate) comprises a housing in which the lever 35 is concealed when it is in its neutral position. Thus, in order to modify the configuration of the movement, in particular to wind it or set the display members, the user must grasp the free end 50 of the control lever 35 and remove it from the housing while pivoting the lever in relation to the case. The first internal lever 45, integral with the connecting stem 39, comprises three successive portions 51, 52, 53, substantially rectilinear and connected two by two via two bends 54 and 55. This lever 45 comprises a pin 56 arranged in the region of the first bend 54 and extending along a direction substantially perpendicular to the general plane of the lever 45. Moreover, this lever also comprises an opening 57 with a bent oblong shape extending on both sides of the second bend 55 of the lever, both on its second 52 and its third 53 rectilinear portions.

A second substantially rectilinear lever 60 is fixed to the frame of the module by a first 61 of its ends, while being free to turn in relation to an axis X, while its second end 62 is located in the region of the third portion 53 of the first lever 45. In particular, the second end 62 of the first lever 60 is controlled by the oblong opening 57 of the first lever 45 via a shouldered screw 63, integral with the second lever 60 and whereof the head is located on the side opposite that of the first lever, in relation to the second lever. The ends of the second lever are arranged on both sides of a plane P containing the axis of the hand-setting stem and being perpendicular to the general plane of the second lever 60.

Moreover, the second lever 60 comprises a pin 64 extending, in a direction substantially perpendicular to the general plane of the lever, toward the hand-setting stem 13. More precisely, this last part has an annular groove 65 (FIG. 1) inside which the free end of the pin 64 is engaged.

The control mechanism comprises a third 70 and fourth 80 additional internal levers.

The third lever 70 has two substantially rectilinear portions 71, 72 connected by a bend 73, in the region of which is arranged a pivot axis 74 of this lever in relation to the additional module. A substantially rectilinear slot 75 is arranged in the region of a first free end of the third lever, while its second free end supports a pin 76, similar to that of the first lever 45 and extending in the direction of the bottom of the case. The third lever 70 is positioned in the additional module such that its pivot axis 74 and its second end are respectively arranged on both sides of the plane P previously defined. More precisely, the third internal lever 70 is arranged such that the slot 75 of its first end cooperates with the pin 56 of the first lever 45.

The fourth internal lever 80 has three substantially rectilinear portions 81, 82, 83 connected two by two via two bends 84, 85. A first, short portion 81 has a slot 86, open on a first free end of the lever and extending up to the second portion 82 while presenting a bend. The fourth internal lever 80 is made integral with the additional module by an axis of rotation 87 located in the region of the bend 85 connecting the second 82 and third 83 portions of the lever. This bend 85 being located in immediate proximity to the second lever 60, it has a cutout 88 allowing free movements of one of these levers in relation to the other. The second free end of the fourth lever 80 is located between the middle 2 and the lateral part 400 of the rotating bezel and supports a pin 89 extending in the direction of the pinion 17, to cooperate with an annular groove 90 (referenced in FIG. 1) of its primary portion 19.

The control mechanism also comprises a pull-out lever 100 whereof a first beak 101 is arranged in the groove 65 of the hand-setting stem 13 and whereof a second beak 102 is designed to act on an additional lever (not illustrated), traditionally, in order to move the clutch-pinion 30 and activate or deactivate the setting function.

A curved spring 104 is also provided to allow the user to better feel the changes in the configuration of the movement when he manipulates the external control lever 35, in particular between the neutral and intermediate positions. The curved spring 104 is fixed on the additional module by a base 105, while its free end 106 presents a position and a shape adapted to cooperate with the pin 56 of the first internal lever 45. Thus, the free end of the curved spring has two adjacent support surfaces 107, 108 associated with the first two configurations of the movement.

The toothing of the second ring 24 as well as the pinion 28 are also visible in FIGS. 3a to 3c.

FIGS. 3a to 3c illustrate a preferred variation of embodiment of a movement according to the present invention comprising, in addition to what has just been described, a mechanism displaying the position in which the external control lever 35 is found at any moment.

This display mechanism comprises a ratchet 110 whereof the non-toothed end 111 is integral in rotation with the connecting stem 39, and therefore the external control lever 35. The toothing of the ratchet 110 meshes with a pinion 112 mounted coaxial to and integral in rotation with a disc 113 indicating the position of the external control lever. The disc 113 thus bears the inscriptions 0, 1 and 2, as non-limiting information, to indicate that the external control lever is found, respectively, in its neutral position, in its intermediate position and in its position farthest away from the middle, which corresponds as will be described below to the neutral, winding and setting positions. We have also diagrammatically illustrated, in FIGS. 3a to 3c, a triangular window 114 cut out in the frame 12 and through which the position indications are made visible for a user.

The operation of the control mechanism will now be described in relation to FIGS. 3a to 3c.

The external control lever 35 is in the neutral or locking position in the configuration of FIG. 3a, which is indicated by the number 0 across from the triangular window 114. It is close to the middle. One notes that, in this position of the external control lever, the toothing 21 of the pinion 17 is not engaged with the pinion 28. As a result, turning the rotating bezel drives the rotation of the pinion 28 without driving the rotation of the hand-setting stem.

When the control lever is pulled in its intermediate position, or position 1, it causes the first internal lever 45 to pivot clockwise in the figures to bring it into the position of FIG. 3b. In its pivoting movement, the first internal lever 45 does not act on the second lever 60 because of the shape of its oblong opening 57. Thus, when the external control lever 35 goes from its 0 position to its 1 position, the hand-setting stem 13 remains immobile along its axial direction.

However, at the same time, the pin 56 acts on the slot 75 of the third internal lever 70 and drives a pivoting of the latter in the counterclockwise direction which then itself acts on the fourth internal lever 80 via its pin 76. Given the shape of its slot 86, the fourth lever is driven in a clockwise rotational movement, which leads to the application of a traction by its pin 89 on the groove 90 of the pinion 17. The pinion is thus pulled toward the center of the movement, engaging its toothing 21 with the pinion 28.

This position corresponds to that illustrated in FIG. 1, in which it appears that, when the rotating bezel 4 is actuated by the user, the hand-setting stem 13 is driven in rotation to complete the winding of the movement, via the winding pinion 32 and the crown wheel 33.

When the control lever 35 is pulled from its intermediate position into its setting position 2, it causes the first internal lever 45 to pivot in the clockwise direction of rotation to bring it into its position of FIG. 3c.

During this movement, the first internal lever 45 is driven in rotation and acts on the second lever 60, via its oblong opening 57, to cause it to turn counterclockwise. The second internal lever 60 then in turn acts on the hand-setting stem, via its pin 64 and the pull-out lever 100, to move it in its axial direction, outwardly. At the same time, the clutch-pinion 30 is moved, via the pull-out lever 100. The control mechanism is then arranged so as to enable setting of the timepiece by turning the rotating bezel.

Moreover, one sees in FIG. 3c that, during the passage of the external control lever 35 from its position 1 to its position 2, the force exerted by the first internal lever 45 on the third internal lever 70 causes the latter to turn slightly, which causes a movement of its pin 76 in the slot 86 of the fourth internal lever 80. The latter has an orientation such that, during this operation, the pin 76 of the third lever 70 does not exert any force on the fourth lever 80 which, as a result, remains immobile. Thus, the pinion 17 remains engaged with the pinion 28 to provide the kinematic connection between the rotating bezel and the hand-setting stem.

When the external control lever is brought back from its position 2 to its position 1, then to its position 0, the control mechanism has movements opposite those which have just been described.

To summarize the operation of the control means of the timepiece according to the preferred embodiment illustrated in the figures, one will note that the passage of the external control lever 35 from position 0 to position 1 establishes a kinematic connection between the rotating bezel 4 and the hand-setting stem 13 in order to make it possible to wind the movement, without moving the stem insofar as it is connected, by default, to the winding means. The passage of the lever 35 from position 1 to position 2 causes the movement of the hand-setting stem 13 to release the winding means and actuate the clutch-pinion 30, which makes it possible to connect the stem to the time display members and perform setting of the timepiece. The state of the kinematic connection between the rotating bezel and the hand-setting stem is not affected during this second passage to enable time setting via rotation of the rotating bezel.

Of course, it is possible to provide that the kinematic connection between the rotating bezel and the hand-setting stem is permanent. In this case, two different positions of the external control lever 35 can be sufficient, namely a first, winding position, and a second, setting position. The passage from one position to the other of the lever would make it possible in particular to activate or deactivate the connection between the hand-setting stem and the display members.

Having three positions of the lever 35 makes it possible to completely uncouple the rotating bezel from the movement in the neutral position of the lever. In this way, it is possible to assign an additional function to the bezel in this position, such as measurement of a diving time for example, without any impact on the operation of the movement.

One may note that certain construction details of the timepiece have been illustrated as examples. In particular, one may note in FIG. 1 that an additional ring 115 is screwed in the bezel 4, this additional ring in turn being held against the middle 2 by the ring 41. The latter is in fact maintained in a predefined position, relative to the middle, by feet 116, one of which is visible in FIG. 1. Each of these feet is made integral with the middle using a screw 117 whereof the head is accessible from the surface of the middle arranged across from the bottom 3. The bottom can be connected to the middle using any suitable means, in particular by cooperation of a threading arranged at its periphery with internal tapping of the middle, by screws visible from the outside of the case, or by a notch connection. Once the bottom is withdrawn from the middle, the screws 117 can be removed to release the lateral part 400 of the bezel, after its upper part 401 and the glass 5 have been removed. Thanks to these characteristics, access to the movement is easy both from its bridge side and from its plate side, which can be particularly advantageous to perform work on the movement.

Moreover, one can provide that the axial maintenance of the connecting stem 39 by the ring 41 is done via a bush 120 (FIG. 2) whereof a first end is housed inside the square portion 44 of the connecting stem while its second end is arranged bearing against the ring 41.

The preceding description corresponds to one preferred embodiment of the invention described as a non-limiting example. In particular, the forms illustrated and described for the different component elements of the timepiece are not limiting.

As an example, one skilled in the art will not encounter any particular difficulties to adapt the number and form of the levers of the control mechanism for his own needs, without going outside the scope of the present invention.

1-10. (canceled)

11. A timepiece comprising
a case comprising a rotating bezel and containing a clockwork movement,
time display means, and
a setting mechanism including a hand-setting stem, housed in its entirety inside said case, and able to be moved between at least one first axial position and a second hand-setting axial position,
connection means able to allow the establishment of a kinematic connection between said rotating bezel and said hand-setting stem such that turning said rotating bezel turns the hand-setting stem,
wherein it also comprises
a external control lever, mounted pivoting on said case, and whereof one end portion is movable between at least a first, neutral position, in which the rotations of the rotating bezel, separated from the movement, have no impact on the operation of said movement, and a second, hand-setting position, and
a control mechanism arranged to act on said hand-setting stem and move it from one axial position to the other in response to action on said control lever causing its end portion to move from one position to the other to enable the hand-setting mechanism to be actuated by turning the rotating bezel.

12. The timepiece according to claim 11, said case comprising a middle, wherein said external control lever is integral in rotation with a connecting stem mounted pivoting in said middle and being substantially perpendicular to a general plane of the latter part, said connecting stem also being integral in rotation with a first internal lever of said control mechanism.

13. The timepiece according to claim 11, said case housing a clockwork movement frame,
wherein said control mechanism comprises a second internal lever, mounted pivoting around an axis X on said frame, and extending along a transverse direction in reference to the longitudinal direction of said hand-setting stem, substantially along a general plane, said second internal lever comprising a region for receiving a force transmitted from said external control lever and a support surface arranged so as to cooperate at least indirectly with said hand-setting stem, and
wherein said reception region and said axis X are respectively arranged on both sides of a plane P containing said hand-setting stem and perpendicular to the general plane of the second lever.

14. The timepiece according to claim 13, wherein said control mechanism comprises at least one additional internal lever arranged to move a clutch-pinion supported by said hand-setting stem simultaneously to the movements of said hand-setting stem from one of its axial positions to the other.

15. The timepiece according to claim 11, wherein said connection means comprise a pinion integral in rotation with said hand-setting stem and able to be moved by said control mechanism to establish a mechanical connection with a wheel kinematically connected to said rotating bezel, without axial movement of said hand-setting stem, in response to an action exerted on said control lever driving a movement of said end portion (50) between said first position and an intermediate, winding position to allow the establishment of said kinematic connection between said rotating bezel and said hand-setting stem.

16. The timepiece according to claim 11, wherein said connection means comprise a ring, integral in rotation with said rotating bezel, and supporting a toothing arranged to cooperate with a wheel able to drive said hand-setting stem in rotation by meshing.

17. The timepiece according to claim 16, comprising a dial above which at least one time display member evolves, said middle being closed by a bottom from its side opposite that of said frame, wherein in transverse cross-section, the ring has, from its external periphery integral with the rotating bezel toward its internal periphery supporting said toothing, a first portion extending substantially along a first plane parallel to a general plane of said middle, a second portion tilted in the direction of the bottom, and a third portion extending substantially along a second plane parallel to said general plane of the middle, the distance separating said first plane from said second plane being greater than the height separating the rotating bezel from the middle.

18. The timepiece according to claim 11, wherein the connecting stem is housed in a hole of said middle, with a substantially cylindrical wall over at least part of its length, and has a cylindrical portion with a diameter smaller than the diameter of said hole, an O-ring being interposed between said stem and said wall.

19. The timepiece according to claim 11, said case being closed by a glass, wherein said glass is supported by the rotating bezel.

20. The timepiece according to claim 12, wherein it also comprises control means for means displaying the position in which said external control lever is found, said control means having a kinematic connection with said hand-setting stem.
